(19) United States
(12) Patent Application Publication
(10) Pub. No.: US 2011/0106573 A1
(43) Pub. Date: May 5, 2011

(54) AUTOMATED MEETING SCHEDULING

(75) Inventor: Patrick McNamara, San Francisco, CA (US)

(73) Assignee: Apple Inc., Cupertino, CA (US)

(21) Appl. No.: 12/610,034

(22) Filed: Oct. 30, 2009

(51) Int. Cl. G06Q 10/00

(52) U.S. Cl. 705/5; 705/7.12; 705/7.19

(57) ABSTRACT

An improved meeting scheduling system that automatically proposes a reduced cost available meeting room for a meeting based on the invited attendees and locations of available meeting rooms. A reduced cost available meeting room may be the meeting room to which the attendees as a whole are presumed to be nearest in distance at the time the meeting begins. In addition to the proximity or distance of each of the attendees to the available meeting rooms, other relevant data concerning the attendees may be factored by the meeting scheduling system such as the hierarchy of an attendee in relation to the other attendees, attendee security access privileges to a particular location, and the distances between attendees.

### BACKGROUND

An embodiment of the invention generally relates to computer calendar applications that allow a user to schedule meetings at various locations in a campus environment. Other embodiments are also described.

Modern computer calendar systems allow users to schedule and distribute meeting requests amongst invited attendees. In scheduling the meeting, the user of a computer calendar system has two choices in determining a location for the meeting. The user may either pick a location irrespective of the locations of each invited attendee prior to the meeting or the user may attempt to coordinate a location by communicating with each of the invited attendees.

Picking a meeting location irrespective of the locations of each of the attendees may result in many of the invited attendees traveling extreme distances to attend the meeting. The inconvenience in traveling to distant locations to attend meetings may have undesirable effects on the meeting including delayed meeting starts and possibly low attendance. Further, coordinating the location of a meeting by communicating with each of the invited attendees can be tedious and unproductive as this approach essentially requires a meeting to organize the location of a future meeting.

### SUMMARY

An embodiment of the invention is directed to an improved meeting scheduling system that automatically proposes a reduced cost available meeting room for a meeting based on the invited attendees and locations of available meeting rooms. In one embodiment, an “optimally located” or “closest” available meeting room is the meeting room to which the attendees as a whole are presumed to be nearest in distance at the time the meeting begins. In other embodiments, in addition to the proximity or distance of each of the attendees to the available meeting rooms, other relevant data concerning the attendees is factored in such as the hierarchy of an attendee in relation to the other attendees, attendee security access privileges to a particular location, and the distances between attendees.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a diagram showing a network calendar system, in accordance with an embodiment of the invention.

FIG. 2 is a screenshot of a meeting request window generated by a calendar application running on a client terminal, in accordance with an embodiment of the invention.

FIG. 3 is a data flow of a process for finding a reduced cost meeting room operation, in accordance with an embodiment of the invention.

FIGS. 4a and 4b show example schedules for attendees of a new meeting.

FIG. 5 shows an example of the mapped locations of invited attendees and available meeting rooms.

FIGS. 6a and 6b show matrices of the distances of invited attendees in relation to available meeting rooms and other invited attendees.

FIG. 7 shows a matrix of the weighted distances of invited attendees in relation to available meeting rooms and other invited attendees.

FIG. 8 is a screenshot of a meeting request window with a presented, reduced cost meeting room, in accordance with an embodiment of the invention.

FIG. 9 is a system diagram of a meeting scheduling system, in accordance with an embodiment of the invention.

### DETAILED DESCRIPTION

Several embodiments of the invention with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

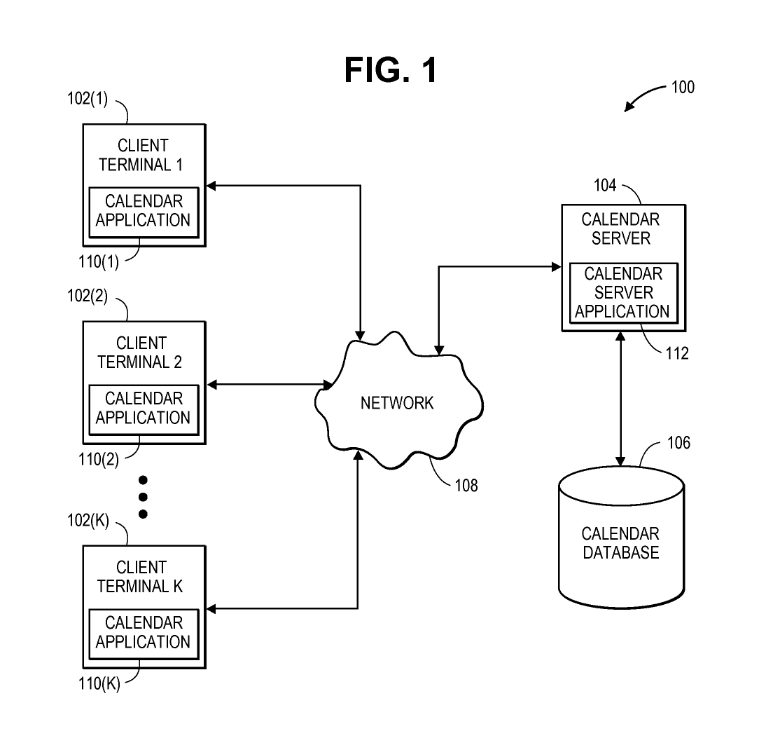

FIG. 1 illustrates a network calendar system 100 in which an embodiment of the invention operates. The network calendar system 100 includes client terminals 102, a calendar server 104, a calendar database 106, and a network 108. The network 108 may be a computer network that covers an area of one or more buildings (e.g. a school or university, an airport, a corporate campus, a military base). The network 108 may be a single local network or it may be a collection of smaller networks connected to each other by routers and/or switches (e.g. a corporate area network or metropolitan area network).

A client terminal 102 may be a desktop computer, a laptop computer, a netbook computer, a personal digital assistant, a cellular telephone, a mobile smart phone, an entertainment system, or other similar computing platform (generically referred to here as a “computer”). The client terminal 102 is capable of running a calendar application 110 (e.g. iCal, Outlook, Entourage, and Meeting Maker calendar applications). The calendar application 110 on each client terminal 102 may be an instance of the same brand of calendar application or it may be a different brand. For example, client terminal 102(1) may be running Microsoft Outlook while client terminal 102(2) may be running iCal from Apple Inc. The calendar applications 110 allow users to create a meeting (event) and distribute an associated meeting request to one or more attendees of the meeting over the network 108. The meeting request informs the attendees of the meeting start-time, the meeting end-time, the meeting location, the meeting subject, etc.

The calendar application 110 of each client terminal 102 may be configured to communicate with a calendar server 104 through the network 108. The calendar server 104 may be a computer system running an email and calendar server application 112 such as Microsoft Exchange or a CalDAV-compliant calendar server application that is capable of distributing meeting requests and meeting information to one or more calendar applications 110 running on one or more client terminals 102. The calendar server 104 accesses and updates meeting information on a calendar database 106. For example, a meeting request created by calendar application 110(1) is transmitted to the calendar server 104 over the network 108 and then stored in the calendar database 106. Thereinafter, the calendar server 104 may access the meeting request stored in the calendar database 106 and transmit it to client terminals 102(1-k) such that attendees may view the details of the meeting request (i.e. the meeting start-time, the meeting end-time, the meeting location, the meeting subject, etc.) and accept or reject the meeting request.

The calendar database 106 may also store data related to meeting rooms and users of the calendar application 110. Meeting room data includes the location of a meeting room (e.g. its geographic coordinates), availability of the meeting room (e.g. whether or not it is reserved for a meeting), resources available in the meeting room (e.g. special video conferencing equipment), etc. User data includes the schedule of a user (including scheduled meeting times and locations), contact information for the user, the user's primary desk location, etc. The calendar database 106 may be implemented using a hierarchical model, network model, relational model, entity-relationship, object-relational model, object model, or any other type of database model. Further, the database may be stored on a centralized server or in a set of distributed storage facilities. For example, in one embodiment each client terminal 102(1-k) may locally store user data for its corresponding or respective user such that the client terminals 102(1-k) form a calendar database. In another embodiment, all users' schedules, related user data and meeting room data for all possible meeting rooms are stored in a centralized server to form a centralized calendar database.

The calendar server 104 may control communications amongst calendar applications 110 and/or between calendar applications and the calendar database 106. In one embodiment, the calendar server 104 assists the client terminals 102 perform operations requested by the calendar application 110. For example, the calendar server 104 may perform a query operation on the calendar database 106 for a calendar application 110 running on a client terminal 102. Upon completion of the query operation, the result of the query operation is returned to the client terminal 102 such that it can be used by the calendar application 110. The calendar server 104 may be implemented as a set of servers in a back-end data center for an enterprise. The network calendar system 100 thus provides an infrastructure framework which allows users the ability to create and distribute meeting requests.

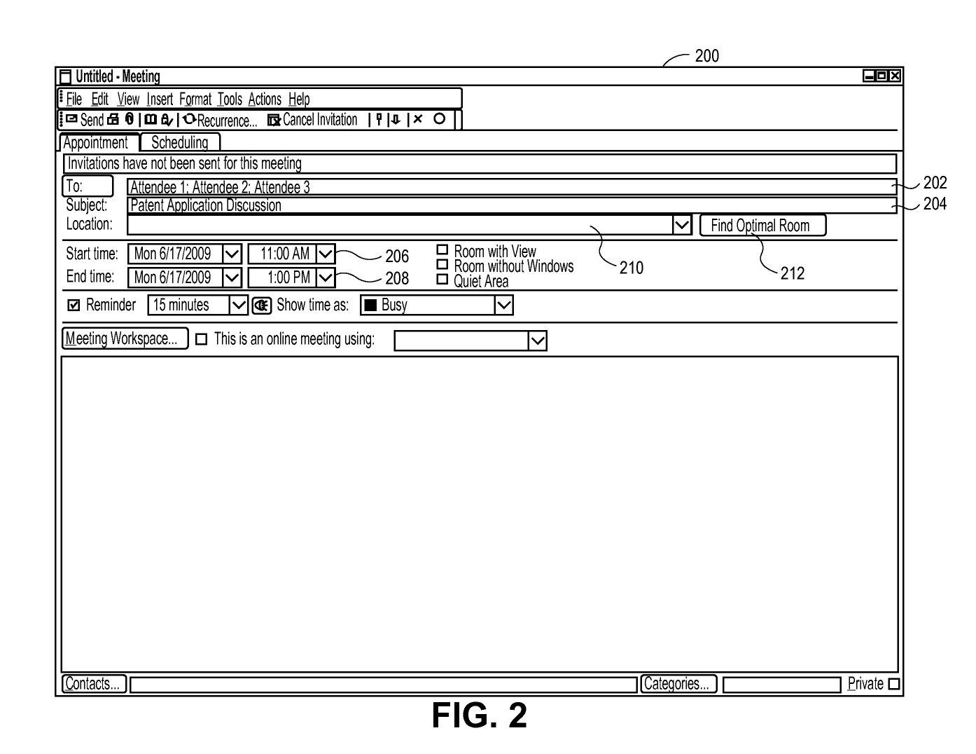

Turning now to the operation of the calendar application 110, FIG. 2 illustrates a meeting request graphical user interface window 200 which is generated by the calendar application 110(1) running on the client terminal 102(1). The meeting request window 200 is presented to a user of the calendar application 110(1) upon the user selecting the creation of a new meeting in the calendar application 110(1). The meeting request window 200 includes an attendee entry dialog 202, a meeting subject entry dialog 204, a meeting start-time entry dialog 206, a meeting end-time entry dialog 208, a meeting location or room entry dialog 210 (for manual selection of the meeting room by the user), and a find reduced cost room button 212.

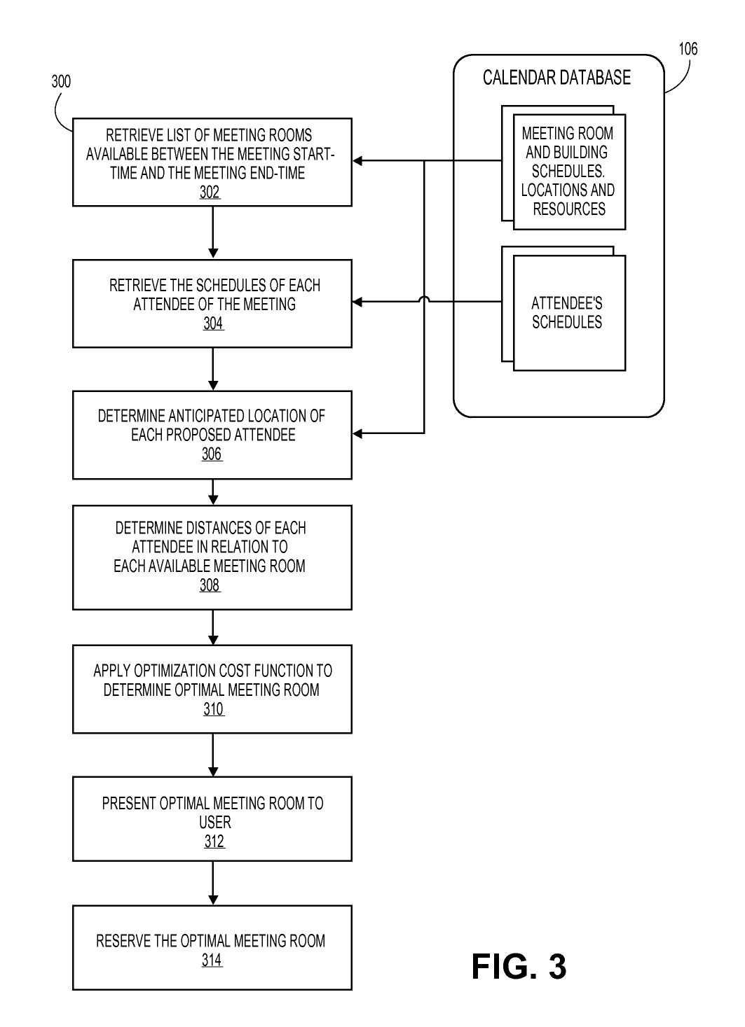

Upon entering the list of invited attendees into the attendee entry dialog 202, a meeting start-time into the meeting start-time entry dialog 206, and a meeting end-time into the meeting end-time entry dialog 208, the user may select the find reduced cost room button 212 by using a mouse, keyboard, voice, or other input device connected to the client terminal 102(1). Selection of the find reduced cost room button 212 initiates an instance of the find meeting room process 300 as shown in FIG. 3, which automatically selects an available meeting room that is expected to result in reduced cost or be more efficient for to the attendees. In one embodiment, a meeting room that has a reduced cost in comparison to other meeting rooms is a meeting room which is closest in distance in relation to each attendee of a meeting or collectively amongst all attendees of a meeting. In one embodiment, the find meeting room process 300 is entirely performed by the client terminal 102(1) which initiated the process 300, specially programmed by its application software. In another embodiment, the find meeting room process 300 is performed jointly by both the client terminal 102(1) and the calendar server 104.

FIG. 3 illustrates a data flow for one embodiment of the find meeting room process 300 as performed within the network calendar system 100. In this embodiment, the process 300 selects an available meeting room that is most efficiently located between or “closest” to all invited attendees of the meeting.

The process 300 may be initiated by a user as described above selecting the find reduced cost room button 212 in the meeting request window 200 of the calendar application 110(1). In another embodiment, the process 300 may be automatically started after a user has entered a list of invited attendees into the attendee entry dialog 202, a meeting start-time into the meeting start-time entry dialog 206, and a meeting end-time into the meeting end-time entry dialog 208.

Following the commencement of the process 300, a list of meeting rooms that are available at the date and time of the new meeting is retrieved in operation 302. In one embodiment, the list of available meeting rooms is retrieved from the calendar database 106. Particularly, a query requesting a listing of available meeting rooms may be transmitted from the calendar application 110(1) to the calendar server 104 and then performed on the calendar database 106. The query includes a meeting start-time and a meeting end-time which had been designated by the user in the meeting request window 200. The calendar server 104 performs the query on the calendar database 106 and returns the resulting list of available meeting rooms to the calendar application 110(1). The list of available meeting rooms may include all meeting rooms that are not reserved and are otherwise available between the meeting start-time and a meeting end-time.

In one embodiment, the query may include a list of resources required during the new meeting. For example, the query may indicate a need for a projector or other visual aid device during the new meeting. Accordingly, the list of available meeting rooms in that case may include meeting rooms available during the chosen time period which also contain the designated resource. In one embodiment, the client terminal 102(1) assists the calendar server 106 in executing the query by jointly performing the query on the calendar database 106.

To determine the meeting room that is closest to the set of invited attendees, the distances between available meeting rooms and attendees prior to the meeting start-time is determined. To do so, the location of each available meeting room and the anticipated locations of each invited attendee just prior to the meeting start-time are determined. In one embodiment, a user may specify the time prior to the meeting at which the process 300 determines the anticipated locations of each invited attendee. For example, a user may request the anticipated locations of each invited attendee ten minutes prior to the start-time of the meeting.

The location of each meeting room may be stored in the calendar database 106. The location of each meeting room is retrieved along with the list of available meeting rooms in operation 302 of the find meeting room process 300. The location of each meeting room may be formatted as latitude and longitude parameters.

In operation 304, the schedules of each invited attendee are retrieved. In one embodiment, each invited attendee has an account in the networked calendar system 100 such that the schedule of each attendee is available to the process 300. In one embodiment, the schedule of each invited attendee is stored in the calendar database 106 of the networked calendar system 100 while in another embodiment the schedule of each invited attendee is stored on each attendee's corresponding client terminal 102.

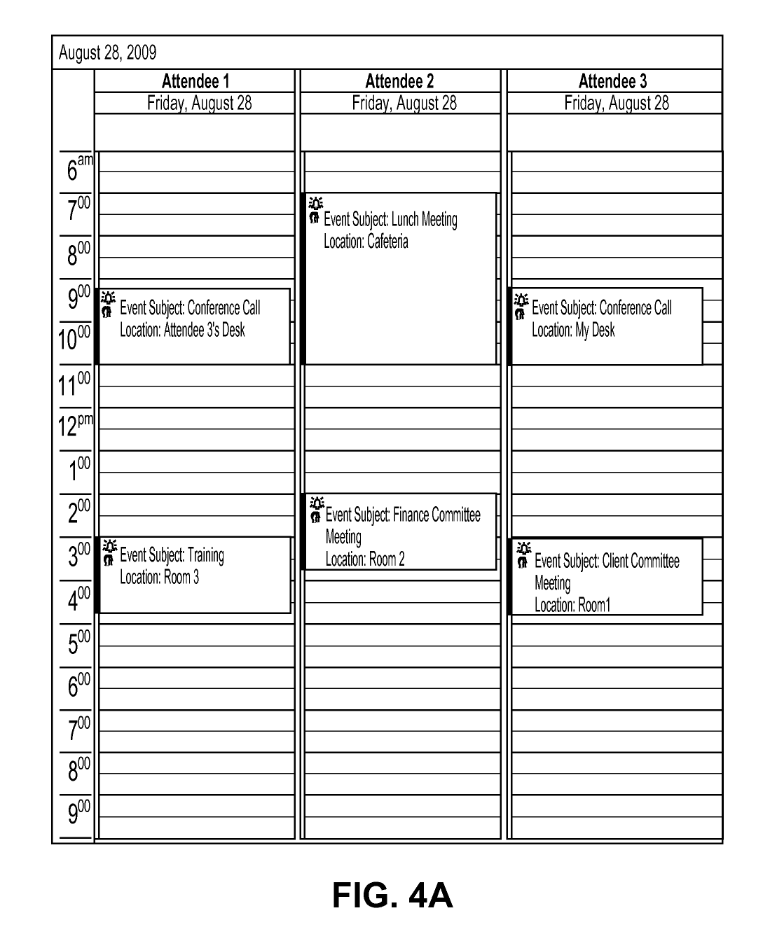

FIG. 4a illustrates example schedules of attendee 1, attendee 2, and attendee 3 who are each an invited attendee to the new meeting. The schedules of the three invited attendees in FIG. 4a are represented as a graphical chart however the schedules of each invited attendee may be stored in an alternate form such as a data structure, a file, or other medium capable of storing meeting schedules.

Each event/meeting in the invited attendees' schedules includes a start-lime, an end-time, and an event/meeting location. FIG. 4b illustrates the schedules of the invited attendees with the new meeting, “Patent application discussion”. In this example, the new meeting has a start-time of 11:00 a.m.

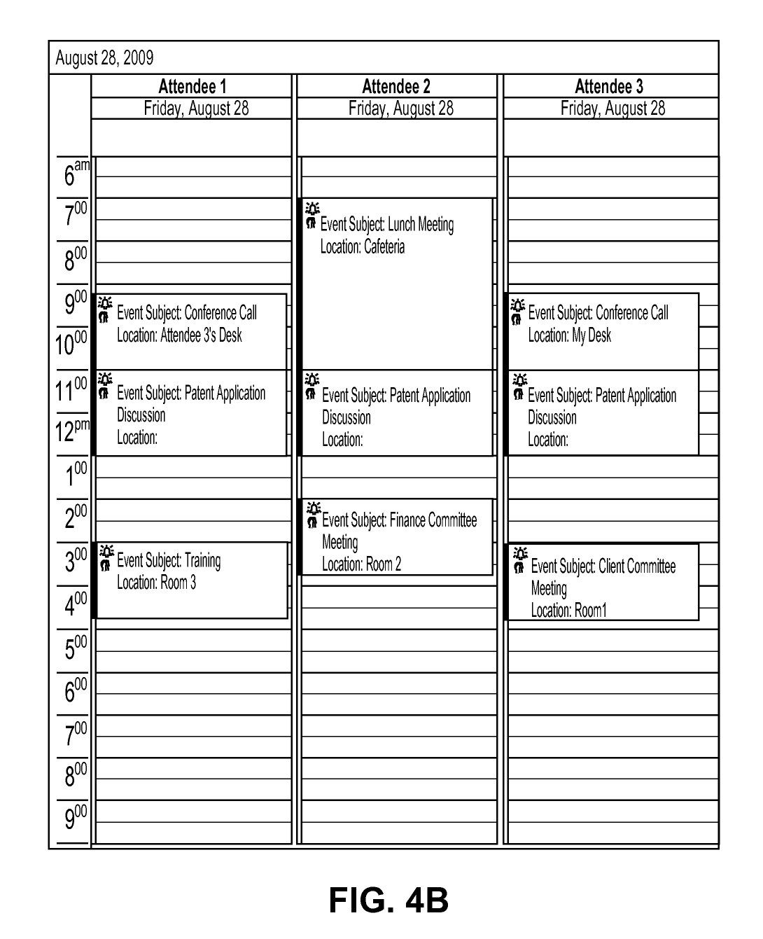

FIG. 5 illustrates mapped locations of the invited attendees 1-3 and several available meeting rooms 1-3 just prior to (e.g. five minutes before) the meeting start-time of the new meeting. As shown in FIG. 5, attendee 1 and attendee 3 are located in attendee 3′s office and attendee 2 is located in the cafeteria.

Returning to FIG. 3, in operation 306, the find meeting room process 300 determines the anticipated location of an invited attendee prior to the start-time of the meeting is determined. This may be done by retrieving from each invited attendee's schedule the location of the event/meeting that is scheduled just prior to (e.g. fifteen minutes before the start-time of the new meeting. For example, as seen in FIG. 4b, attendee 2 is determined to be in the cafeteria prior to the start-time of the new meeting based on her retrieved schedule. After determining attendee 2 is located in the cafeteria, the coordinates of the cafeteria are retrieved from the calendar database. These coordinates will then represent the location of attendee 2 just prior to the start-time of the new meeting.

If no meeting location is noted in an invited attendee's schedule or the invited attendee does not have a scheduled event/meeting prior to the start-time of the new meeting, the invited attendee may be assumed to be at their desk location. In one embodiment, the desk location of attendees is retrievable from the calendar database 106.

In one embodiment, the actual and current locations of an invited attendee may be used (in place of the anticipated location) to select a reduced cost meeting room from the listing of available meeting rooms. This may be helpful when organizing a meeting close to its start-time. The actual current locations of the invited attendees may be obtained by using Global Positioning System (GPS), transmitted by a mobile communication device of each invited attendee, an RFID tag attached to each invited attendee, RF triangulation of the mobile communication device of each invited attendee, or similar methods which would return actual current locations.

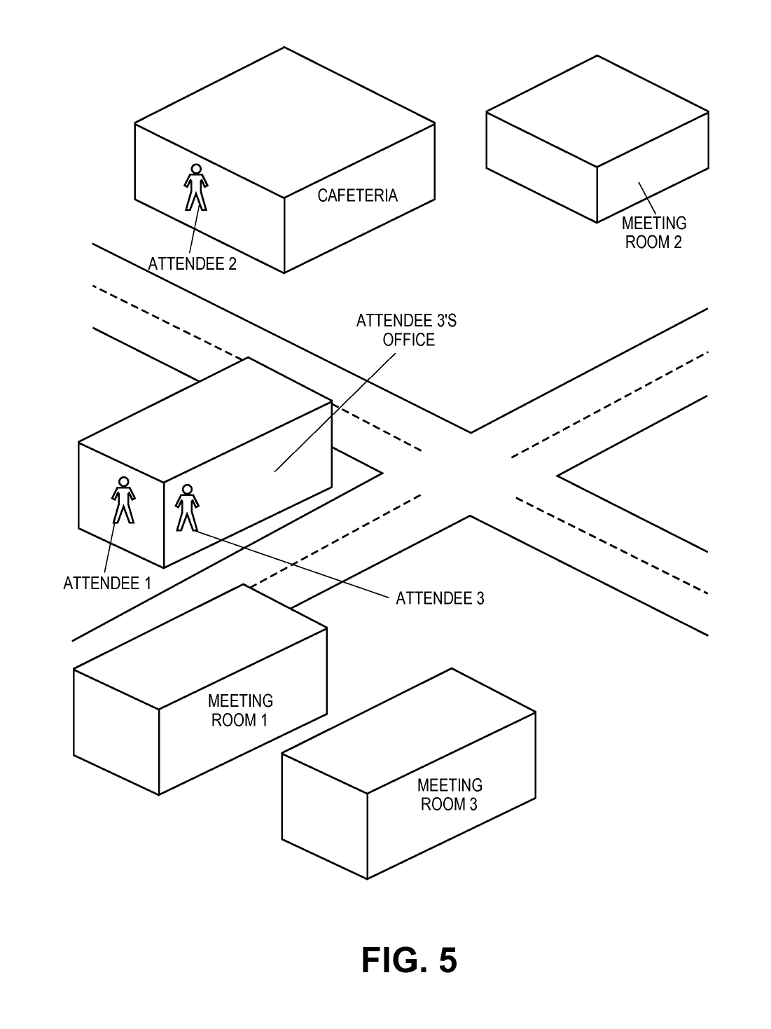

After determining the location of each invited attendee and each available meeting room, the find meeting room process 300 determines the distances between the available meeting rooms and the invited attendees, in operation 308. FIG. 6a illustrates a matrix of the distances of invited attendees 1-3 in relation to available meeting rooms 1-3 and other invited attendees. The distances may be defined in any suitable units (e.g. feet); they may be actual walking distances, or they may be approximate distances in a limited number of ranges (e.g. 0 indicates less than 25 feet; 1 indicates 25-75 feet; etc.).

In operation 310, an optimization cost function is applied to the distances between available meeting rooms and invited attendees to select a reduced cost meeting room. In one embodiment, either the mean or median distance associated with each available meeting room may be used by the optimization cost function. For example, the available meeting room with the lowest mean or median distance in relation to the attendees is the reduced cost meeting room. FIG. 6b illustrates a matrix of the distances of attendees 1-3 in relation to available meeting rooms 1-3 and other invited attendees as shown in FIG. 6a along with the mean and median distances associated with each available meeting room.

To illustrate the operation of the find meeting room process 300, an optimization cost function involving mean and medians will be used hereinafter. However, in other embodiments, alternative optimization cost functions that are more complex for example may be used. For example, an optimization cost function which selects a reduced cost meeting room by setting goals of minimization may be used. In these embodiments, the total distance traveled by invited attendees to a meeting room may be defined by yₜ=x₁z₁+x₂z₂+ . . . +x_{w}z_{w}, where zᵢ represents the distance traveled by an invited recipient to a meeting room t and xᵢ represents a weighting factor (e.g. driven by hierarchy, xxx location, etc.) applied to an invited recipient.

Accordingly, the minimization goal would be set to minimize the value y (i.e. min(y)) and consequently arrive at a reduced cost meeting room.

Returning to FIG. 6b, in one embodiment, the mean distance computed for each meeting room is compared to find the lowest mean distance and consequently the reduced cost meeting room. In this embodiment, the median distance of each meeting room may not be needed to determine the reduced cost meeting room.

In other embodiments, the median distance computed for each meeting room may be used to lessen or eliminate the effects of statistical outliers. Statistical outliers may include one or more attendees that are unusually distant from the other attendees. A large difference between the median distance and the mean distance of invited attendees in relation to a meeting room is a strong indicator of a statistical outlier. Specifically, a large difference between the mean and median of a meeting room indicates that one or more of the attendees are far away from the other attendees. There are two main approaches for ensuring statistical outliers do not harmfully affect the selection of the reduced cost meeting room.

In one embodiment, the optimization cost function in operation 310 compares the mean and median distances computed for each meeting room to determine if their difference is greater than a predefined amount. If the difference between the mean and median of one or more meeting rooms is greater than a predefined amount, the mean is not used to determine the reduced cost meeting room. In such a situation, the median may be a better determinant of the reduced cost meeting room. Thus, instead of using the mean distances of the meeting rooms, the median distances of the meeting rooms are compared to each other, to determine a reduced cost meeting room. By comparing the median distance instead of the mean distance, the effect of a statistical outlier in the determination of a reduced cost meeting room may be reduced or eliminated.

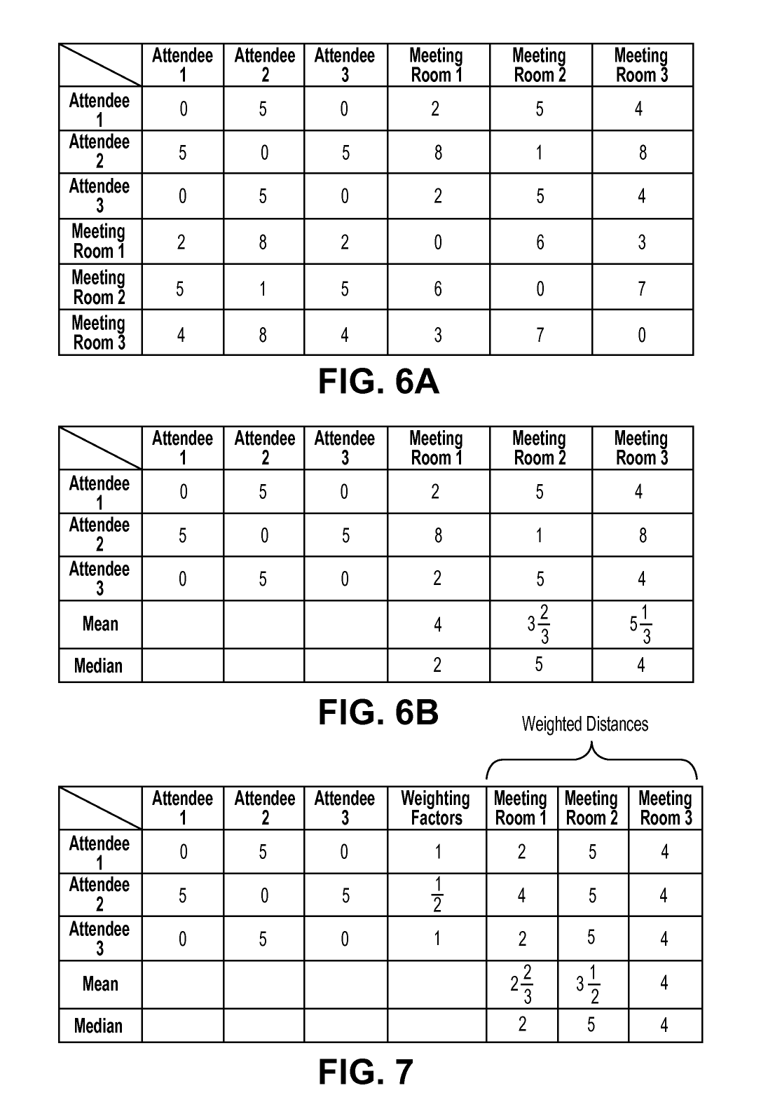

In another embodiment, weighting factors are assigned to one or more invited attendees such that the effect of statistical outliers may be reduced. FIG. 7 illustrates the assignment of weighting factors to each invited attendee. In this example, attendee 2 is significantly separated or different from attendees 1 and 3. Thus, the optimization cost function at operation 310 designates attendee 2 as a statistical outlier. To mitigate the effects of attendee 2 on the determination of a reduced cost meeting room, a weighting factor of ½ is assigned to attendee 2 while a weighting factor of 1 is assigned to both attendees 1 and 3. In one embodiment, the weighting factor of each invited attendee is then multiplied with the distances associated with each attendee to produce weighted distances. By multiplying the distances associated with the outlier attendee (i.e. attendee 2) with a smaller weighting factor, his weighted distances are lessened and consequently the effect of the statistical outlier on the determination of the reduced cost meeting room is lessened. These weighted distances are then used to calculate the mean and median distances of each meeting room. By associating a weight with each attendee, the optimization cost function at operation 310 reduces the effect of a statistical outlier.

Alternatively, in some embodiments weighting factors may be used to “force an outlier” (i.e. reduce the importance of an invited attendee in relation to the selection of a reduced cost meeting room, i.e. so that he will have little impact on the decision). In these embodiments, weighting factors are applied to values associated with the invited attendee that is forced to be an outlier such that the values are reduced in value.

In some embodiments, weighting factors may be used for other purposes besides reducing the effects of statistical outliers. For example, weighting factors may be used to show a preference for one or more attendees. For instance, a high ranking member of an organization may be assigned a weighting factor greater than others to demonstrate a preference for his/her location in determining the reduced cost meeting room. Weighting factors may also be assigned to handicap attendees such that the distance they need to travel is potentially decreased.

In other embodiments, weighting factors may be applied to available meeting rooms to encourage or discourage the use of particular meetings rooms. For example, the surrounding area of a meeting room may be particularly noisy. Thus, this meeting room is less preferred than other quieter locations. Accordingly, weighting factors are appropriately assigned to each meeting room in this example to reflect desirability of a given meeting room. In a similar fashion to the use of weighting factors with invited attendees, a weighting factor in this situation may be multiplied by the distances associated with its associated meeting room during the optimization cost function of operation 310.

In another embodiment, weighting factors may be applied to meeting rooms based on “wellness” characteristics. For example, lower weights may be assigned to meeting rooms with a view, quieter areas, rooms without windows for privacy, etc. such that these meeting rooms would be more likely to be selected as the reduced cost meeting room using the optimization. In this embodiment, the user may select a preference for particular “wellness” characteristics of a meeting room while creating a new meeting using, for example, the meeting request window 200 e.g using a set of checkbox widgets added to the GUI which allow the user to select/ deselect particular attributes, to be included (or not) in the optimizer process.

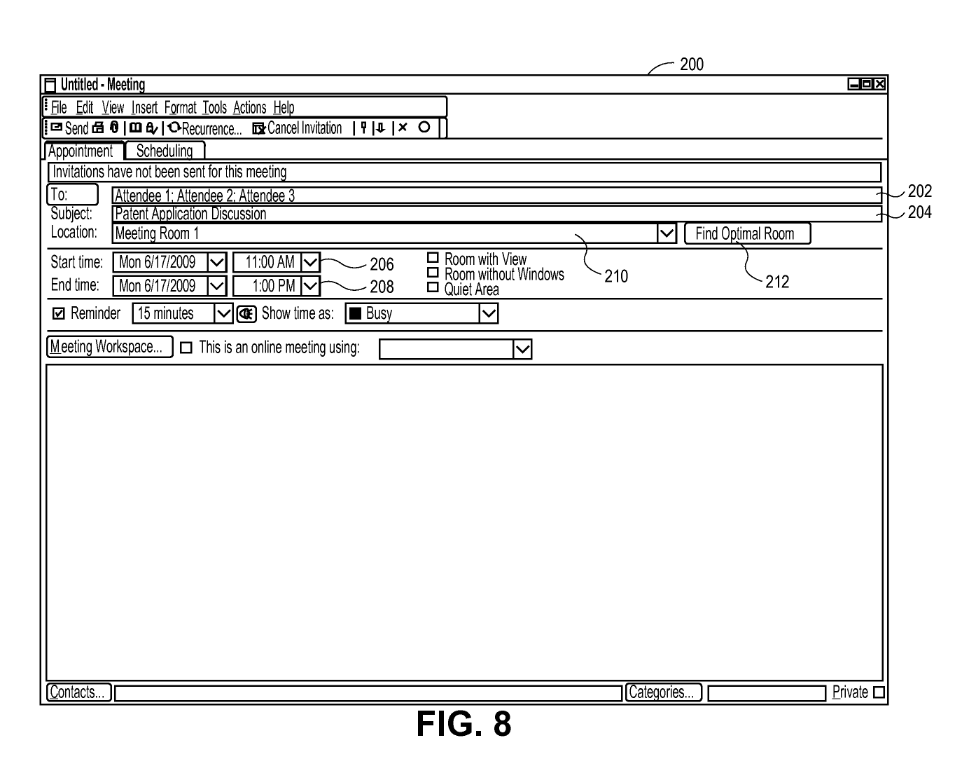

After the optimization cost function in operation 310 has completed and has determined a reduced cost meeting room, this reduced cost meeting room may be presented to the user in operation 312. In one embodiment, the reduced cost meeting room is presented to the user by identifying the reduced cost meeting room in the meeting location entry dialog 210 of the meeting request form 200 as shown in FIG. 8.

After the reduced cost meeting room has been presented to the user, the user may thereafter accept or reserve the room and send the meeting request (bearing the identity of the reduced cost room) to the invited attendees. Alternatively, the user could select a different room in the meeting location entry dialog 210. In one embodiment, sending the meeting request bearing the reduced cost meeting room automatically accepts or reserves the reduced cost meeting room for the new meeting.

In one embodiment, the find meeting room process 300 may be run again after one or more invited attendees have rejected the meeting request and/or after one or more invited attendees' schedules have changed. By running the find meeting room process 300 after one or more invited attendees have rejected the meeting request and after one or more invited attendee's schedules have changed, a potentially new reduced cost meeting room may be selected for the meeting which takes into account the changes to attendees' schedules and the list of potential attendees to the meeting. If the new reduced cost meeting room is different from the previous reduced cost meeting room, invited attendees are informed of the change. In one embodiment, the find meeting room process 300 runs automatically after an invited attendee's schedule has change and/or an attendee rejects the meeting request. In another embodiment, the find meeting room process 300 is manually invoked after an invited attendee's schedule has change and an attendee rejects the meeting request.

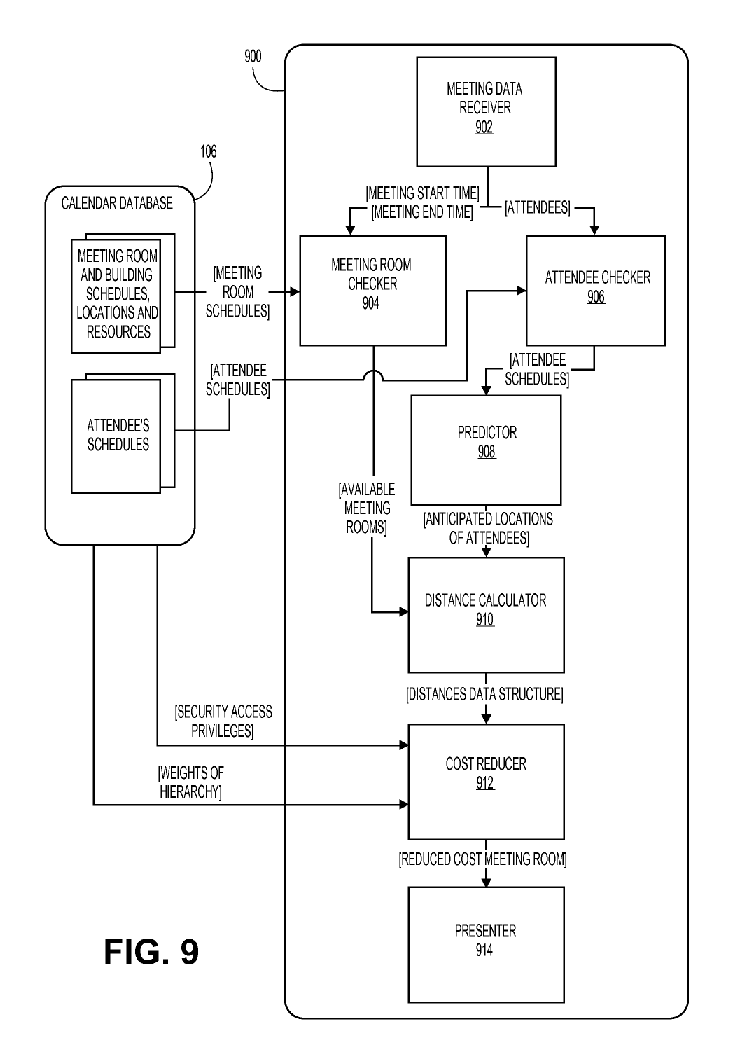

FIG. 9 illustrates a system diagram for one embodiment of a find meeting system 900 which may operate within the network calendar system 100. The components of the find meeting system 900 may be specially programmed processors e.g. exclusively on either a client terminal 102 or the calendar server 104, or in combination on both a client terminal 102 and the calendar server 104. In one embodiment, some or all of the operations of the find meeting room process 300 may be performed by the components of the find meeting system 900 as described below.

The find meeting system 900 commences operation after receiving meeting information from an external source (e.g. a meeting request graphical user interface window 200 of a calendar application 110). The meeting information may include meeting start-time, meeting end-time, meeting attendees, and other pieces of meeting information entered into a meeting request graphical user interface window 200. The meeting data receiver 902 makes the meeting information available to the other system components of the find meeting system 900 through a push or pull data retrieval schema.

In one embodiment, the meeting room checker 904 receives a meeting start-time and a meeting end-time from the meeting data receiver 902 and constructs a query to obtain a listing of available meeting rooms based on this received meeting information. After constructing the query, the meeting room checker 904 processes the query on a listing of meeting rooms stored in the calendar database 106 and outputs a list of meeting rooms that are available between the meeting start-time and the meeting end-time. In one embodiment, operation 302 of FIG. 3 may be performed by the meeting room checker 904.

The attendee checker 906 receives a list of attendees from the meeting data receiver 902 and retrieves each attendee's schedule from the calendar database 106. The attendee checker 906 thereafter outputs the schedules of each attendee. In one embodiment, operation 304 of FIG. 3 may be performed by the attendee checker 906.

The predictor 908 receives the schedule of each attendee from the attendee checker 906. Based on these schedules, the predictor 908 computes an anticipated location for each attendee at or just prior to the meeting start-time (which is retrieved from the meeting data receiver 902). The predictor 908 thereafter outputs the anticipated location of each attendee. In one embodiment, operation 306 of FIG. 3 may be performed by the predictor 908.

The distance calculator 910 receives the anticipated location of each attendee at the meeting start-time from the predictor 908 and the list of meeting rooms that are available between the meeting start-time and the meeting end-time from the meeting room checker 904. Based on these inputs, the distance calculator 910 calculates the distance of each attendee in relation to every other attendee and each meeting room. These distances are output from the distances calculator 910 into a data structure. The distance calculator 910 thereafter outputs the calculated distances. In one embodiment, operation 308 of FIG. 3 may be performed using the distances calculator 910.

The cost reducer 912 receives the calculated distances from the distances calculator 910. Based on the calculated distances and optional weights assigned to invited attendees and meeting rooms, the cost reducer 912 calculates a cost reduced meeting room (selects one) from the list of available meeting rooms. In one embodiment, the mean and median distances between attendees and meeting rooms are determined to calculate the cost reduced meeting room. These mean and median vales may be stored in the data structure output by the distance calculator 910. FIGS. 6a and 6b show matrices which may be created by the cost reducer 912. Based on the mean and median distances between attendees and meeting rooms, the cost reducer calculates a cost reduced meeting room. The cost reducer 912 thereafter outputs the cost reduced meeting room. In one embodiment, operation 310 of FIG. 3 may be performed by the cost reducer 912.

The presenter 914 receives the cost reduced meeting room from the cost reducer 912. The presenter 914 presents the reduced cost meeting room to the user. In one embodiment, the presenter 914 presents the reduced cost meeting room) to the user by inserting a value (which identifies the reduced cost meeting room into the meeting location or room entry dialog 210 of the meeting request graphical user interface window 200. In one embodiment, operation 312 of FIG. 3 may be performed by the presenter 914.

Finally, the presenter 914 may also reserve the cost reduced meeting room for the user upon its acceptance by the user. In one embodiment, this is done by associating the meeting room in the calendar database 106 with the user and the request for a new meeting, and sending a corresponding meeting request (that identifies the cost reduced meeting room)to the invited attendees. If the user does not accept the reduced cost meeting room, he may enter a different location manually into the meeting location entry dialog 210.

To conclude, various aspects of a technique for scheduling a meeting with a reduced cost meeting room have been described. As explained above, an embodiment of the invention may be a machine-readable medium such as one or more solid sate memory devices having stored thereon instructions which program one or more data processing components (generically referred to here as “a processor” or a “computer system”) to perform some of the operations described above. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although the described instances of the find meeting room process is triggered by the creation of a new meeting, the find meeting room process could also be performed on already created meetings without the trigger of a new meeting. The description is thus to be regarded as illustrative instead of limiting.

What is claimed is:

1. A computerized method for scheduling a meeting, comprising:
creating a meeting event in a calendar application for a designated date and time;
assigning a plurality of attendees to the meeting event;
prior to the meeting time, accessing information about the plurality of attendees and location information for a plurality of meeting rooms;
analyzing the information about the plurality of attendees and the location information for the plurality of meeting rooms; and
automatically selecting one of the plurality of meeting rooms for the meeting event as being closest to the plurality of attendees.

2. The method of claim 1, wherein said accessing the information about the plurality of attendees comprises:
retrieving a schedule of each of the attendees, wherein each of the attendees has an account in the calendar application with which the schedule is associated.

3. The method of claim 1, wherein said analyzing the information about the plurality of attendees and the location information for the plurality of meeting rooms comprises:
determining an anticipated location of each attendee prior to the commencement of the meeting based on the information about the plurality of attendees; and
determining distances of each attendee in relation to each meeting room based on the anticipated location of each attendee and the location information for the plurality of meeting rooms.

4. The method of claim 3, wherein said automatically selecting one of the meeting rooms comprises:
selecting the closest meeting room based on the anticipated location of each attendee prior to the commencement of the meeting, the location information for the plurality of meeting rooms and predefined weighting factors.

5. The method of claim 1, further comprising:
presenting the selected meeting room to a user of the calendar application; and
reserving the selected meeting room for the meeting event in response to input from the user.

6. The method of claim 4, wherein at least some of the predefined weighting factors are assigned to attendees based on their hierarchy in an organization.

7. The method of claim 4, wherein at least some of the predefined weighting factors are assigned to attendees based on the anticipated location of each attendee in relation to the anticipated location of every other attendee, such that attendees anticipated to be in close proximity to other attendees are assigned higher predefined weighting factors than attendees anticipated to be distant from the other attendees.

8. The method of claim 4, wherein at least some of the predefined weighting factors are assigned to the plurality of meeting rooms based on characteristics of each meeting room.

9. The method for scheduling the meeting of claim 1, wherein said accessing the information about the plurality of attendees comprises:
retrieving current location information of one of the attendees.

10. An article of manufacture comprising a machine readable medium having stored instructions that, when executed by a computer system:
prior to a start time of a meeting stored in a calendar application, access information about a plurality of attendees of the meeting, determine distances between each attendee and a plurality of meeting rooms, and
automatically select one of the plurality of meeting rooms for the meeting event as having a reduced cost to the plurality of attendees.

11. The article of manufacture of claim 10, wherein the machine readable medium has instructions that cause the computer system to access the information about the plurality of attendees by retrieving schedules of each of the attendees.

12. The article of manufacture of claim 10, wherein the machine readable medium has instructions that causes the computer system to:
derive a mean for each meeting room based on the distances between each attendee and the meeting room; and
wherein selection of one of the plurality of meeting rooms with lowest cost is based on the mean of each meeting room.

13. The article of manufacture of claim 10, wherein the machine readable medium has instructions that causes the computer system to:
present the selected meeting room to a user of the calendar application; and
reserve the selected meeting room for the meeting event in response to input from the user.

14. The article of manufacture of claim 12, wherein the meeting room with lowest cost is the meeting room with the lowest mean.

15. The article of manufacture of claim 14, wherein the machine readable medium has instructions that causes the computer system to:
derive a median for each meeting room based on the distances between each attendee and the meeting room,
wherein for a meeting room in which the difference between the mean and the median is greater than a predefined amount, the median is used in place of the mean to determine the meeting room with lowest cost.

16. The article of manufacture of claim 10, wherein the predefined weighting factors are assigned to attendees based on their hierarchy in an organization.

17. The article of manufacture of claim 10, wherein accessing the information about the plurality of attendees comprises retrieving current location information of attendees.

18. A system for scheduling a meeting, comprising:
a meeting room checker for determining available meeting rooms between a meeting start-time and a meeting end-time;
an attendee checker for retrieving schedules of each meeting attendee;
a predictor for predicting locations of meeting attendees at the meeting start-time;
a distance calculator for calculating distances between attendees and available meeting rooms;
a cost reducer for determining a reduced cost meeting room amongst the available meeting rooms; and
a presenter for presenting the reduced cost meeting room to a user.

19. The system for scheduling the meeting of claim 18, further comprising:
a meeting data receiver for receiving meeting information, including the meeting start-time, the meeting end-time and the meeting attendees.

20. The system for scheduling the meeting of claim 18, wherein the cost reducer:
selects the closest meeting room based on anticipated locations of each attendee prior to the commencement of the meeting, the location information for the plurality of meeting rooms and predefined weighting factors.

21. The system for scheduling the meeting of claim 18, further comprising:
a presenter for presenting the selected meeting room to a user of the calendar application; and
reserving the selected meeting room for the meeting event in response to input from the user.
